(19) United States
(12) Patent Application Publication
(10) Pub. No.: US 2023/0283620 A1
(43) Pub. Date: Sep. 7, 2023

(54) SYSTEMS AND METHODS FOR MONITORING ANOMALOUS MESSAGES BASED ON RELEVANCE TO A PROCESS

(71) Applicant: RECOLABS LTD., TEL AVIV (IL)

(72) Inventor: TAL SHAPIRA, TEL AVIV (IL)

(21) Appl. No.: 17/875,562

(22) Filed: Jul. 28, 2022

Related U.S. Application Data
(63) Continuation-in-part of application No. 17/861,215, filed on Jul. 10, 2022.
Application No. 17/861,215 is a continuation-in-part of application No. 17/687,757, filed on Mar. 7, 2022.

(51) Int. Cl. H04L 9/40; H04L 51/04

(52) U.S. Cl. CPC H04L 63/1425; H04L 51/04; G06F 40/205

(57) ABSTRACT

A computer-implemented method for monitoring anomalous messages, the method including monitoring a message sent from a sender user to a recipient account, extracting multiple text elements from the message, computing a text relevance score for a specific text element, the text relevance score indicates a relevance between the specific text element and a specific process, identifying the specific text element as unique to the specific process related to the recipient account according, computing a sender relevance score that indicates a relevance between the sender user and the specific process, performing a security operation on the message based on the sender relevance score and failure to identify a text element of the message as unique to the specific process related to the recipient.

### FIELD AND BACKGROUND

The invention, in some embodiments thereof, relates to access control and, more specifically, but not exclusively, to systems and methods for securing files and/or records.

Traditional approaches for securing files and/or records include user set passwords, a user providing links to other users for accessing the file, and an administrative setting permission levels for users.

### SUMMARY

In one aspect of the invention a computer-implemented method is provided for monitoring anomalous messages, the method including monitoring a message sent from a messaging account associated with a sender user to a recipient account, extracting multiple text elements from the message, computing a text relevance score for a specific text element of the multiple text elements, wherein the text relevance score indicates a relevance between the specific text element and a specific process of multiple processes, identifying the specific text element as unique to the specific process related to the recipient account according to a difference between a first text relevance score computed between the specific text element and the specific process and a second text relevance score computed between the specific text element and other processes of the multiple processes, computing a sender relevance score, the sender relevance score indicates a relevance between the sender user and the specific process, performing a security operation on the message based on the sender relevance score and failure to identify a text element of the message as unique to the specific process related to the recipient.

In some cases, the message is an electronic mail message. In some cases, the message is an instant messaging message. In some cases, the message is a Short Message Service (SMS). In some cases, the message is sent via a business communication application. In some cases, the security operation includes generating a security alert corresponding to the sender user and to the monitored message. In some cases, the security operation includes delaying the message before received at the recipient account. In some cases, the security operation includes blocking the message from receipt at the recipient account. In some cases, security operation includes sending the message to an analysis messaging account for analysis. In some cases, security operation includes filtering an alert. In some cases, security operation includes assigning a score to security alerts provided by a third party.

In some cases, computing the sender relevance score further includes collecting a plurality of interaction events between the sender user and users and at least one of files and records identified as related to the specific process. In some cases, collecting the plurality of interaction events is performed using at least one of a group including a code sensor, an application programming interfaces (APIs) and a virtual interface, installed on a device operated by the users. In some cases, the interaction events are associated with an interaction contribution date, wherein a weight of at least some of the interaction events decreases over time.

In some cases, plurality of interaction events is selected from a group consisting of participating in an online meeting, organizing the online meeting, accessing a calendar event, sending email, receiving email, reading a file, sharing a file, creating a file, editing a file, accessing a record, reading a record, sharing a record, creating a record, and editing a record.

In some cases, the target interaction weight between the target user and the at least one of messaging account and a user associated with the messaging account is computed as a function of at least one of (i) interaction weights between the target user and at least one other user having interaction weights with the user associated with the messaging account, and (ii) interaction weights between the target user at least one other user having interaction weights with the messaging account.

In some cases, monitoring the attempt at a messaging server communicating with the recipient account to which the message was sent. In some cases, the plurality of interaction events are arranged in an interaction graph, wherein the method further includes updating the interaction graph with new interactions. In some cases, the interaction graph includes nodes representing one of a specific user, a specific record, a message sent from a sender to a recipient account and a specific file. In some cases, the method further includes computing a risk level score according to the difference between the target interaction weight and the threshold. In some cases, the method further includes identifying one or more specific processes related to the recipient account. In some cases, the method further includes monitoring a message sent from a messaging account associated with a sender user to a recipient account. In some cases, extracting the multiple text elements from the message includes extracting the multiple text elements from fields selected from the message's subject, attachment's name, a domain associated with the sender, a sender's name, message body, and a combination thereof.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of securing files and/or records according relevance to a specific process, in accordance with some embodiments of the invention;

FIG. 2 is a flowchart of a method of creating the interaction data related to a specific process, in accordance with some embodiments of the invention;

FIG. 3 is a flowchart of a method of refining the interaction data related to a specific process, in accordance with some embodiments of the invention;

FIG. 4 is a flowchart of a method of performing actions on the refined interaction data related to a specific process, in accordance with some embodiments of the invention;

FIG. 5 is a block diagram of a system of securing files and/or records according to relevance of a specific person to a specific process, in accordance with some embodiments of the invention;

FIG. 6 is a flowchart of a method for securing at least one of files and records related to a specific process, in accordance with some embodiments of the invention;

FIG. 7 is a flowchart of a method for creating a security rule in a security software, in accordance with some embodiments of the invention; and

FIG. 8 is a flowchart of a computer-implemented method for monitoring anomalous messages related to a specific process, in accordance with some embodiments of the invention.

### DETAILED DESCRIPTION

The invention, in some embodiments thereof, relates to access control and, more specifically, but not exclusively, to systems and methods for monitoring anomalous messages.

An aspect of some embodiments of the invention relates to systems, methods, an apparatus, and/or code instructions (e.g., stored on a memory and executable by one or more hardware processors) for securing files and/or records from access by a target user. The instructions include obtaining interaction data including one or more persons and one or more files and/or records, identifying, from the interaction data, one or more persons and one or more files and/or records related to the specific process, comparing a process threshold with a process interaction score between a target user and the specific process, and in response to the comparison satisfying a rule, performing a security operation on the one or more files and/or records related to the specific process.

At least some implementations described herein address the technical problem of securing files and/or records, for example, controlling user access to files, folders or directories that store files or to software applications that contain files or links to files, such as Instant messaging applications such as Teams, Slack, email applications and the like. At least some implementations described herein address the technology of automated securing of files and/or records, for example, automated control of user access to files. On the one hand, granting users security clearance (e.g., full access) to files promotes team work on the files, for example, including other users which are not part of an organization. Different users may collaborate together on the file. On the other hand, lowering securing (e.g., enabling unrestricted access) to the files and/or records opens the door for malicious activity, such as unauthorized distribution of the file, stealing of intellectual property and other organization secrets, and/or opening a door for attacks on data. At least some implementations described herein address the technical problem, and/or improve the technology, by dynamically assigning security operations on files and records based on the specific business process the files are related to. The access of the target user to a specific file or record is dynamically determined based on current interactions patterns, which may indicate, for example, whether the user requires access to the file, such as a score indicating a level or relevance between the target user and the specific process. Unauthorized access to the file may be blocked, for example, when the user distributes a file to a friend which is not part of the organization, access by the friend to the file is blocked.

The technical problem and/or technology of securing files and/or records, for which at least some embodiments described herein provide a solution and/or improvement to the technology, optionally automatically, may related to one of more of:
Security—Alert decluttering—for example, data leakage prevention (DLP)). For each incident, the context (e.g., business context) of the action (for example file access/download) may be determined (e.g., interpretability) as described herein and/or the access may be determined to be legitimate or not as described herein. The number of false alerts may be significantly reduced using at least some implementations described herein.
Security—reduce risk by identifying a unique kind of alert—actions without any context (e.g., business context) may be found as described herein, and therefore malicious actions by an insider or other malicious activity may be identified. These actions may be identified using available anomaly detection approaches.
Security—IR (Incident Respond)—upon a security event, related actions and/or context (e.g., business context) may be provided as described herein to significantly reduce the TTR (time to respond).
Information technology (IT)—Access request (authorization management)—upon a user's request to get access to a file or record, whether the user has business justification may be determined as described herein, the context to approve may be provided to IT (e.g., to an administrator).
IT—least privilege access—when a user no longer has business justification for the access may be determined as described herein, and IT may be provided the context to remove permissions.
Other—information retrieval—for any user who wishes to find other business interactions which are related to the specific action.

At least some implementations described herein address the technical problem of processing interaction events between users and other users, and/or between users and files, in order to determine whether a specific user is to be granted access to, or blocked from, accessing a specific file. At least some implementations described herein address the technical problem, and/or improve the technology, by an unsupervised, and/or self-supervised approach in which the files and persons are identified as related to a specific process or not related to a specific process. When a file is determined as related to a specific process, security operations are applied on the file, for example changing permissions to the file based on the specific process. In case a target user wishes to perform an action on a file identified as related to a specific process, and the target user is not related to the specific process, the target user will be denied from performing the action.

At least some implementations described herein address the technical problem of interpretability of an automated security process that secures access to files and/or records, for example, automatically controls access (i.e., grants and/or blocks) to specific files and/or records by specific users. At least some implementations described herein improve the technology of automated security of files and/or records, for example, automated control of access to specific files by specific users. At least some implementations described herein address the technical problem, and/or improve the technology, by providing the basis for the security, for example, for an access control decision. The security may be determined (e.g., access control decision may be made) based on a likelihood that the requesting user is related to the same business process that the file is related to. The interpretability of the security (e.g., decision) may be based on providing the basis for the computation of the relevance of a person or file to a specific process used to determine the security (e.g., access), based on interaction events associated with anchors related to the specific process. The interpretability of the security (e.g., decision) may be used, for example, by an administrator evaluating blocked file accesses, to determine whether the target user is performing malicious activity on the files, such as copying, sending the files, accessing data stored in the files etc.

With the increased number of incidents that concerned data/assets access and the transition to software as a service (SaaS) Apps, it is difficult or even impossible to understand the context behind them. Furthermore, there is friction between the willingness to secure the organization with the business that wants to run forward.

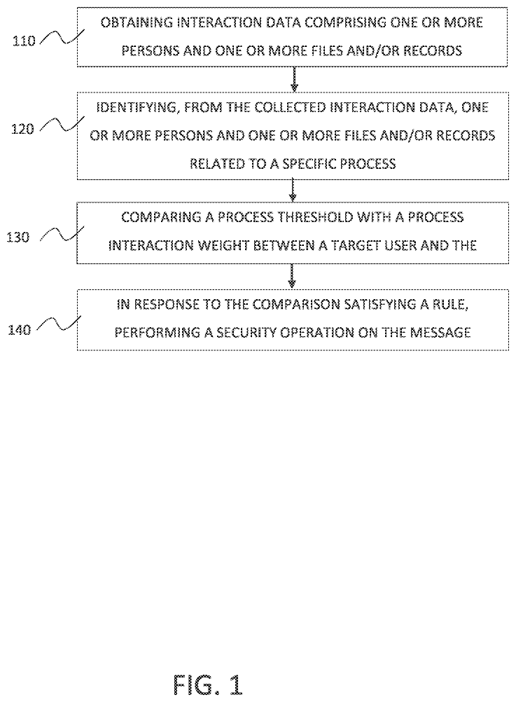

FIG. 1 is a flowchart of a method of securing files and/or records according relevance to a specific process, in accordance with some embodiments of the invention.

At 110, the method discloses obtaining interaction data including one or more persons and one or more files and/or records. The interaction data may be collected as part of the process, or be provided to the entity performing the processes elaborated below from another entity, whose mission is to collect data about interactions between persons and/or files. The interaction data includes interaction events, such as participating in an online meeting, organizing the online meeting, accessing a calendar event, sending messages, receiving messages, reading a file, sharing a file, creating a file, editing a file, accessing a record, reading a record, sharing a record, creating a record, and editing a record. The messages may be email messages, SMS messages, messages over a business communication application such as Slack, Jira, and other software-based applications that enable transfer of messages between employees in an organization.

The interaction data may be an analysis product of the interaction events. For example, accumulate all the interaction events between users to assign a score to the connection between these two users. similarly, assign a value to an interaction between a user and a file or record based on the activity the use had with the file, such as reading the file, sending the file, editing the file, copying the file, renaming the file and the like.

The interaction data may include a process interaction score between a target user and the specific process. The process interaction score represents a unique relationship between a specific person and the specific process. The specific person may be an employee in the organization, a contractor, a client, a vendor and the like. The process interaction score may change over time, for example by computing the process interaction score once a week. For example, in case the specific person is no longer involved in the specific process, the process interaction score decreases. The process interaction score may be represented as a number. The methods, techniques and processes used to compute the process interaction score may vary over time, and are generally selected by a persons skilled in the art. The process interaction score may be computed using various metrics, for example number of interaction events, weights of interaction events, a value represented by a graph created by the interaction events, algorithms executed on graphs such as centrality score, PageRank and the like.

Optionally, the interaction events are normalized. The normalization is performed to enable aggregating different interaction events together, and/or to enable cross checking the different interaction events.

Optionally, the interaction events are pre-processed and/or normalized by combining data logs from different data sources. For example, from email addresses mentioned in logs obtained from different data sources, duplicates are removed.

The process interaction score between a specific user and a file and/or target record may be computed as a function of interaction scores between the target user and/or one or more other users having interaction weights with the specific process.

Interaction weights between the target user and the other users may be compared to a threshold. Interaction weights between the target user and the other users having values above the threshold may be considered to be significant for computing the process interaction score. Interaction weights between the target user and the other users having values below the social connection threshold may be ignored in the computation of the process interaction score.

Alternatively, or additionally, the process interaction score between the target user and the specific process may computed according to interaction weights between the target user and another file and/or another record, where the another file and/or another record have interaction weights with other user(s) known as related to the specific process.

At 120, the method discloses identifying, from the collected interaction data, one or more persons and one or more files and/or records related to a specific process. The identification may begin with a process and anchors known to be related to the process. The anchors may be persons or files that are clearly involved in the process. Then, the identifying includes identifying other persons who had relatively high interactions with the anchors, for example over messages or by editing the file known as related to the specific process. The outcome of this process is a list of persons and files/records related to the specific process.

The specific process may be a region of responsibility in an organization, for example accounting, marketing, patent filing, human resources, IT and the like. The specific process may be defined as a set of actions required to be performed by an organization in order to achieve a business goal, such as paying employees' salaries, verifying that all the organization's computers function sufficiently, preparing business contracts with clients and the like. For example, the anchors for the accounting process may be a CFO and other employees having finance in their job description.

At 125, the method discloses detecting a target user trying to perform an action on a file identified as related to the specific process. The action may include changing rules related to access/permission to the file. The action may be opening the file, editing the file, deleting the file, sending the file via a message, copying the file to another memory address and the like. The detection may be provided from an operating system controlling an operation of a device on which the file is stored, for example a server, a laptop, a data storage service such as AWS, google docs and the like.

At 130, the method discloses comparing a process threshold with a process interaction score between a target user and the specific process. The process threshold may vary from one process to another, for example according to the process importance or confidentiality level. The process threshold may vary over time, for example during patent litigation all the files related to patents require a higher threshold than in usual times in order for a person to access them.

At 140, the method discloses in response to the comparison satisfying a rule, performing a security operation on the message. Examples of security actions include”
Filtering security alerts and/or alert decluttering, for example DLP. The security alerts may be generated, for example, by a security monitoring process. Alerts that correspond to the target user and the target file and/or target record may be flagged with a flag indicating that the security alert is real. Alerts that do not correspond to the target user and target file and/or target record may be assumed to be false positives, and ignored. The number of false alerts may be significantly reduced.
Access by the target user to the target file and/or target record may be automatically blocked, for example, by an IT application. For example, the access privileges of the target user are changed, the target user is kicked out of the current application running the target file and/or record, and a connection established by the target user to the target file and/or record is terminated.
Risk may be reduced by identifying a unique kind of alert—actions without any context (e.g., business context) may be found as described herein, and therefore malicious actions by an insider or other malicious activity may be identified. These actions may be identified using available anomaly detection approaches.
Security—IR (Incident Respond)—upon a security event, related actions and/or context (e.g., business context) may be provided (e.g., email, pop-up, notification, alert messages) to significantly reduce the TTR (time to respond).
Information technology (IT)—Access request (authorization management)—upon a user's request to get access, whether the user has business justification may be determined as described herein, the context to approve may be provided to IT (e.g., to an administrator) for example, as an email, pop-up notification, push notification, alert, and the like.
IT—least privilege access—when a user no longer has business justification for the access may be determined as described herein, and IT may be provided the context to remove permissions.

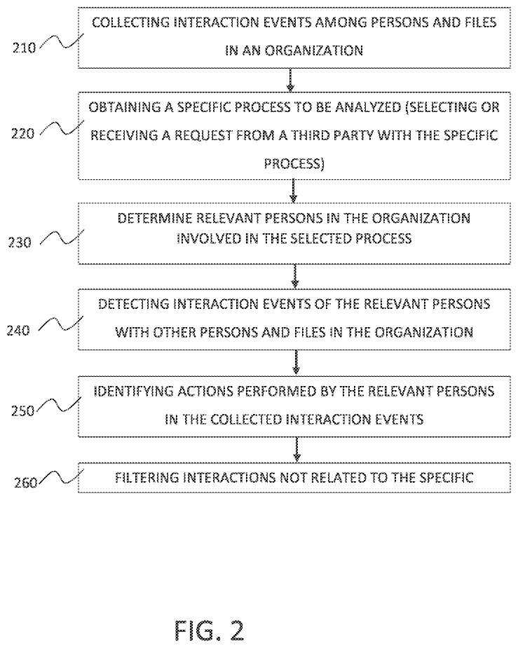

FIG. 2 is a flowchart of a method of creating the interaction data related to a specific process, in accordance with some embodiments of the invention.

At 210, the method discloses collecting interaction events among persons and files in an organization. Interaction with files may relate to a user accessing the actual code of the file, for example, opening a file, reading a file, and editing a file. Interaction with records may relate to a user accessing an instance of data without necessarily accessing the code itself, for example, a user uses an online interface to search a database for a certain record.

The interaction events may be obtained from multiple data sensors and/or multiple interfaces (e.g., application programming interface (APIs)) that monitor user interactions, for example, monitor interactions over a network and/or within interaction applications.

Examples of interaction events include participating in an online meeting, organizing the online meeting, accessing a calendar event, sending messages, receiving messages, reading a file, sharing a file, creating a file, editing a file, accessing a record, reading a record, sharing a record, creating a record, and editing a record.

Examples of combinations (which may be used to create additional larger combinations) of data sources (e.g., APIs) from which interaction events may be obtained include (where each “email”, “calendar” and other source represents one or more possible source such as different email applications by different vendors) Email+Calendar, Instance Messaging+Calendar, Email+Online Meeting, Instance Messaging+Online Meeting, Email+File sharing, Instance Messaging+File sharing, Calendar+File sharing, and Online Meeting+File sharing.

At 220, the method discloses obtaining a specific process to be analyzed (selecting or receiving a request from a third party with the specific process). The specific process may be a region of responsibility in an organization, for example accounting, marketing, patent filing, human resources, IT and the like. The specific process may be defined as a set of actions required to be performed by an organization in order to achieve a business goal, such as paying employees' salaries, verifying that all the organization's computers function sufficiently, preparing business contracts with clients and the like.

In some cases, the process is concluded from one or more persons, as the organization wishes to identify which process are related to a certain person, for example an employee, a contractor, a customer, a vendor and the like.

At 230, the method discloses determine relevant persons in the organization involved in the selected process. The relevant persons may be determined based on text extracted from job descriptions, or manually by persons that initiate the process. The relevant persons are the initial input for the system to process the collected interaction events for the specific process. This way, the files and persons are identified as related to the specific process based on interaction events of persons related to the specific process, not based on the files' content.

At 240, the method discloses detecting interaction events of the relevant persons with other persons and files in the organization. The detected interaction events are selected from the interaction events collected at step 210, for example from APIs and additional resources. The interaction events may be filtered according to rules, for example filter only interaction events of the relevant persons.

At 250, the method discloses identifying interaction events performed by the relevant persons in the collected interaction events. Identifying the actions may be performed by filtering the interaction events according to the persons' names. Not all the interaction events of the relevant persons are associated to the specific process. As such, at 260, the method discloses filtering out interactions not related to the specific process. Filtering may be done according to other persons involved in the same interaction event, for example in case an email message is sent from person A who is known as relevant to the specific process, to person B, who is known as relevant to the specific process, the email is likely to be related to the specific process. If the email includes a header which was found in other files related to the specific process, the interaction event receives a higher relevance score. Additional example for filtering may include a case in which an interaction event involves the entire organization or more than a threshold number of threshold percentage of the organization's employees. Filtering may be performed by various fields, such as user_id or email_account (instead of “user name”, as there could be multiple users with the same name). filtering may relate to various items and types of items, such as messages, files, tasks and the like.

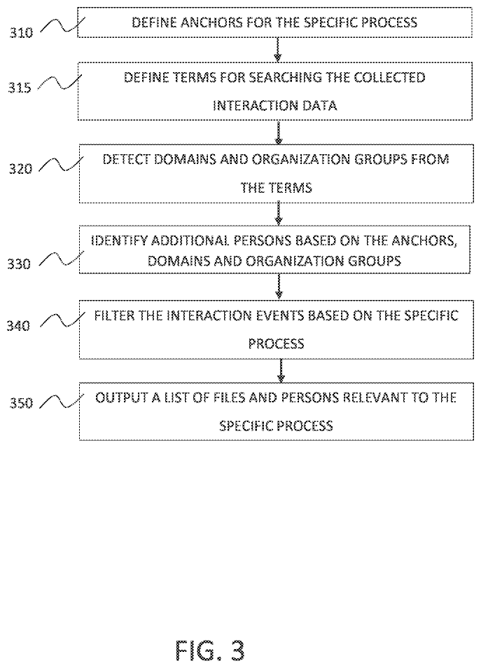

FIG. 3 is a flowchart of a method of refining the interaction data related to a specific process, in accordance with some embodiments of the invention.

At 310, the method discloses defining anchors for the specific process. The anchors may be persons and/or files which are clearly related to the specific process. For example, in case the process is image processing, the anchors will be all the relevant technological people and the files that describe the algorithms. In case the process is marketing in Argentina, the anchors will be the head of marketing and documents having text in Spanish.

At 315, the method discloses defining terms for searching the collected interaction data. Searching may be done in the headers of the files, for example “subject” field of an email message, or also in the body, and in the attachments of the email. The terms may be inputted manually by a person that requests the searching process, or be selected automatically by a computer software, for example as terms which appear in a higher rate (for example, more times per 100 words) in the files already considered as relevant to the specific process.

At 320, the method discloses detecting domains and organization groups from the terms. The domains may represent email accounts or other messaging accounts related to persons outside the organization, such as @amazon.com, or in a specific geography, for example @co.uk, defining an address operating in the United Kingdom. The organization groups may be teams, departments, divisions and the like, for example in the fields of marketing, R&D, legal, finance, Human Resources, sales, technical support and the like.

At 330, the method discloses identifying additional persons based on the anchors, domains and organization groups. The additional persons are also related to the specific process. The additional persons have interaction events with the anchors, such as meetings, exchange of messages, editing and accessing files relevant to the specific process and the like. For example, in case an organization has 180 employees, employees #3, #62 and #115 are defined as anchors, and employees #1, #14, #150 and #78 are identified as additional persons relevant to the specific process based on the interaction data. For example, employees #14 and #150 may be part of the same group as employee #62, who leads the specific process.

At 340, the method discloses filtering the interaction events based on the specific process. This process leaves only the interaction events related to the specific process, filtering out the other interaction events. In some cases, the interaction events are assigned a score, and only events having a score higher than or lower than a threshold are filtered.

At 350, the method discloses outputting a list of files and persons relevant to the specific process. Outputting may be provided by displaying the list on a display device, by sending the list to a messaging account such as email or another business communication application. Outputting may be done by uploading the list to a web page or to a server.

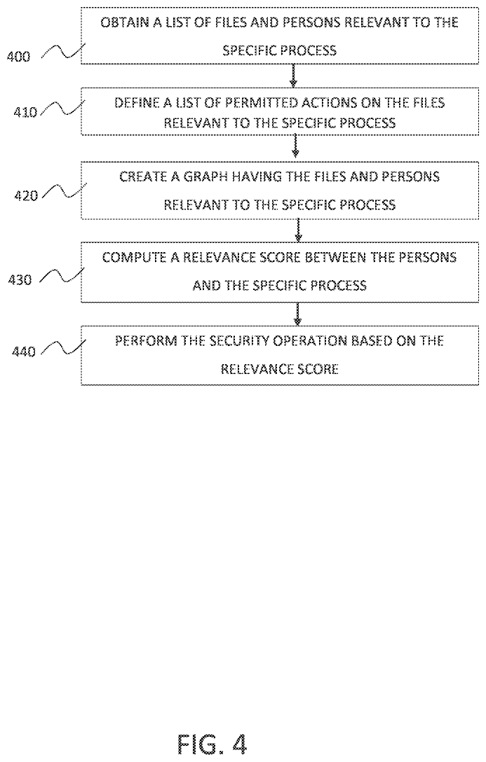

FIG. 4 is a flowchart of a method of performing actions on the refined interaction data related to a specific process, in accordance with some embodiments of the invention.

At 400, the method discloses obtaining a list of files and persons relevant to the specific process. The list may be provided from the processes disclosed above, of identifying the persons and files relevant to the specific process. The number of files and persons relevant to the specific process may vary over time, and may vary from one process to another. The list may be stored in a memory address of an electronic device, for example a server, a database, in a cloud storage service and the like.

At 410, the method discloses define a list of permitted actions on the files relevant to the specific process. The list may include accessing the files, but not editing the files. The list may change according to a relevance score of different persons related to the specific process. For example, 30% of the persons having higher relevance score are permitted to edit files relevant to the specific process, while the other persons relevant to the specific process can only view the files, while other employees in the organization are not permitted to view the files or perform any action on the files relevant to the specific process. The list of actions permitted to persons may vary between processes, for example based on process importance or confidentiality.

At 420, the method discloses create a graph having the files and persons relevant to the specific process. The graph may include nodes representing the files and persons, and edges representing the links between the files and persons according to interaction events. The files and persons may be linked to more than one other node in the graph. At least one of the edges in the graph may have a weight indicating the significance of the interaction events between the two nodes connected by the edge.

At 430, the method discloses compute a process interaction score between the persons and the specific process.

The computation of the process interaction score may be performed in response to monitoring an attempt of the target user to perform an action on the target file. The process interaction scores may be stored in memory addresses of electronic devices and used in response to monitoring such attempt. The process interaction score may change over time, for example according to the time elapsing since the last interaction events of the person and the specific process.

At 440, the method discloses perform the security operation based on the process interaction score. The examples of such security operation are provided above relating to step 140.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The invention may be a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The context (e.g., explanation) may include one or more of:
Other user(s) connected to the target user.
The interaction weights between the target user and the other user(s).
The other file and/or other record.
The interaction weights between the target user and the other file and/or other record.
One or more interaction type category of the interaction between the target user and the other users.
One or more interaction type category of the interaction between the target user and the other file and/or other record.
A time from an interaction of the target user with the target file and/or target record to a current time of the attempted access.
A time from an interaction of the target user with other users that interacted with the target file and/or target record to the current time of the attempted access.
A time from an interaction of the target user with the target file and/or target record to a time from an interaction of the target user with other users that interacted with the target file and/or target record.

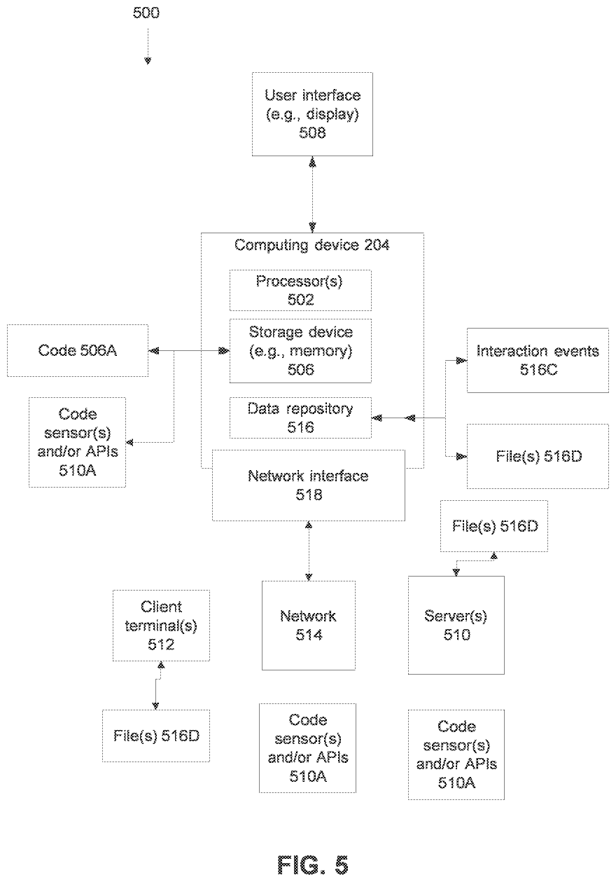

Reference is also made to FIG. 5, which is a block diagram of a system of securing files and/or records according to relevance of a specific person to a specific process, in accordance with some embodiments of the invention.

System 500 may implement the acts of the method described above, by processor(s) 502 of a computing device 504 executing code instructions 506A stored in a storage device 506 (also referred to as a memory and/or program store).

Computing device 504 may be implemented as, for example one or more and/or combination of a group of connected devices, a client terminal, a server, a virtual server, a computing cloud, a virtual machine, a desktop computer, a thin client, a network node, and/or a mobile device (e.g., a Smartphone, a Tablet computer, a laptop computer, a wearable computer, glasses computer, and a watch computer).

Multiple architectures of system 500 based on computing device 504 may be implemented. In an exemplary implementation, computing device 504 storing code 506A may be implemented as one or more servers (e.g., network server, web server, a computing cloud, a virtual server) that provides centralized services (e.g., one or more of the acts described above) to one or more client terminals 512 and/or server(s) 510 over a network 514, for example, providing software as a service (SaaS) to the client terminal(s) 512 and/or server(s) 510, providing software services accessible using a software interface (e.g., application programming interface (API), software development kit (SDK)), providing an application for local download to the client terminal(s) 512 and/or server(s) 510, and/or providing functions using a remote access session to the client terminals 512 and/or server(s) 510, such as through a web browser. For example, computing device 504 centrally monitors interactions between multiple users that use their respective client terminals 512 to access file(s) 516D stored on different locations, for example, on client terminal(s) 512 of the same and/or different users, on server(s) 510, and/or on computing device 504. Computing device may blocks access by specific users to specific file(s) 516D and/or centrally grants access to specific users to access specific file(s) 516D.

In another exemplary implementation, computing device 504 provides local and/or non-centralized services to users of computing device 504. Computing device 504 may include locally stored software (e.g., code 506A) that performs one or more of the acts described herein, for example, as a self-contained client terminal that is designed to be used by users of the client terminal. In such implementation, computing device 504 grants access and/or denies access to file(s) 516D which may be locally stored on computing device 504 to users that use computing device 504.

The interaction events may be stored in an interaction event repository 516C. Interaction events may be collected, for example, by code sensor(s) and/or application programming interface (APIs) and/or other virtual interfaces, which may be installed, for example, on computing device 504, on a network 514, on a server(s) 510, on client terminal(s) 512, and on other devices and/or applications.

Processor(s) 502 of computing device 504 may be implemented, for example, as a central processing unit(s) (CPU), a graphics processing unit(s) (GPU), field-programmable gate array(s) (FPGA), digital signal processor(s) (DSP), an application-specific integrated circuit(s) (ASIC). Processor(s) 502 may include a single processor, or multiple processors (homogenous or heterogeneous) arranged for parallel processing, as clusters, and/or as one or more multi-core processing devices.

Data storage device 506 stores code instructions executable by a processor(s) 502, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Storage device 506 stores code 506A that implements one or more features and/or acts of the method described herein when executed by processor(s) 502.

Computing device 504 may include a data repository 516 for storing data, for example, one or more of interaction event repository 516C, and/or files 516D. Data repository 516 may be implemented as, for example, a memory, a local hard drive, virtual storage, a removable storage unit, an optical disk, a storage device, and/or as a remote server and/or computing cloud (e.g., accessed using a network connection).

Network 514 may be implemented as, for example, the internet, a local area network, a virtual private network, a wireless network, a cellular network, a local bus, a point to point link (e.g., wired), and/or combinations of the aforementioned.

Computing device 504 may include a network interface 518 for connecting to network 514, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Computing device 504 may connect using network 514 (or another communication channel, such as through a direct link (e.g., cable, wireless) and/or indirect link (e.g., via an intermediary computing unit such as a server, and/or via a storage device) with one or more of:
Server(s) 510 which store file(s) 516D that are accessed by users and/or which store code sensor(s) and/or API 510A which monitor interaction events.
Client terminal(s) 512, which may be used by users accessing file(s) 516D (e.g., stored at different locations), and/or which may include code sensor(s) and/or API 510A which monitor interaction events.

Computing device 504 and/or client terminal(s) 512 include and/or are in communication with one or more physical user interfaces 508 that include a mechanism for a user to enter data and/or view data (e.g., read and/or edit files, interact with other users). Exemplary user interfaces 508 include, for example, one or more of, a touchscreen, a display, a keyboard, a mouse, and voice activated software using speakers and microphone.

In another example, justification to access the target file may be provided to internal users that use personal emails to access files. This action, even though it has the potential of being risky, can be legitimate, and should be identified separately than any other access by a personal user.

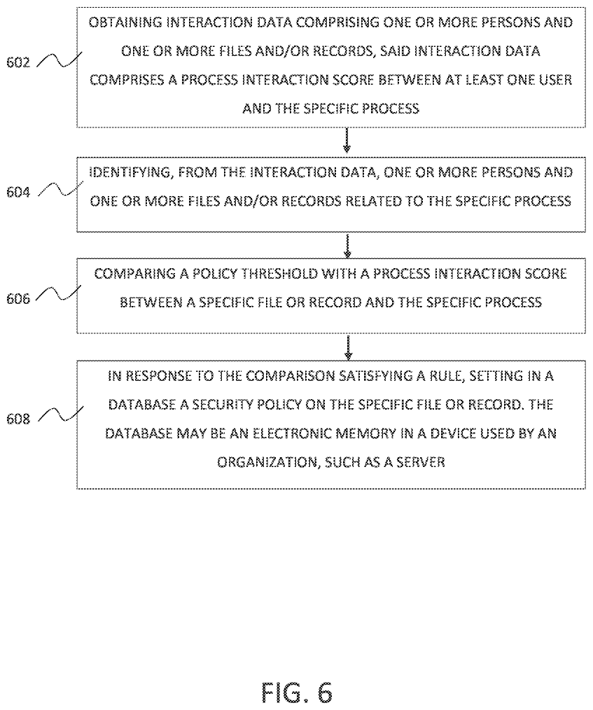

Reference is now made to FIG. 6, which is a flowchart of a method for securing at least one of files and records related to a specific process, in accordance with some embodiments of the invention.

The method solves a technical problem of limited and/or improper tools for assigning policies to files and records. Prior art solutions enable assigning policies to content sent from specific email addresses, for example of a specific person, or assigning policies on files stored in or related to a folder. However, these tools result in irrelevant scenarios, for example limiting email correspondence of non-sensitive email messages in case they are sent from an email account of a person defined as sensitive. That is, policies are assigned regardless of context. In addition, there are tools that assign policies based on content, for example in response to identifying a specific term, such as “contract” or “stock”. These tools require much effort in defining and updating these terms and also result in inaccurate policies.

The invention, in embodiments thereof, provides a process of assigning policies to files and records based on the relevance of the files and records to a specific process.

At 602, the method includes obtaining interaction data including one or more persons and one or more files and/or records, the interaction data includes a process interaction score between at least one user and the specific process. In some cases, the method includes collecting a plurality of interaction events between entities known as related to the specific process and computing the process interaction score according to an analysis of the plurality of interaction events. Collecting the plurality of interaction events is performed using at least one of a group including a code sensor, an application programming interface (APIs), and a virtual interface, installed on a device operated by the users.

At 604, the method includes identifying, from the interaction data, one or more persons and one or more files and/or records related to the specific process. The identification may begin with a process and anchors known to be related to the process. The anchors may be persons or files that are clearly involved in the process. Then, the identifying includes identifying other persons who had relatively high interactions with the anchors, for example over messages or by editing the file known as related to the specific process. The outcome of this process is a list of persons and files/records related to the specific process.

At 606, the method includes comparing a policy threshold with a process interaction score between a specific file or record and the specific process. The policy threshold may be a numeric value. The policy threshold may vary from one specific process to another, for example, based on the importance of a process to the organization. The policy threshold may vary over time, for example in response to an event or in response to collecting interaction events. The specific file or record may be defined as multiple files or multiple records identified as related to the specific process based on the interaction data.

In some cases, the process interaction score between the specific file or record and the specific process is computed as a function of at least one of (i) interaction events between the specific file or record and at least one other user, the interaction events are identified as related to the specific process, and (ii) interaction events between the specific file or record and one or more files and/or records, the interaction events are identified as related to the specific process.

At 608, the method includes in response to the comparison satisfying a rule, setting in a database a security policy on the specific file or record. The database may be an electronic memory in a device used by an organization, such as a server, or memory addresses in a server, a laptop, a data storage service such as AWS, google docs and the like. The database may store a single policy or multiple policies. The policies may be updated by a person via a user interface coupled to the database. Policies may be updated, added, or removed automatically in response to an event, or according to predefined rules. For example, apply a first policy only during weekends. One or more of the policies may be updated in response to the detection of new interactions identified as related to the specific process or to the specific file, such as an attempt to access the specific file related to the policy, or another interaction event.

In some cases, the method includes computing a risk level score according to a difference between the process interaction score and the policy threshold and selecting a security policy from multiple optional security policies based on the risk level score. For example, the multiple optional security policies may be stored in the database being associated with a severity score. Policies with a higher severity score may be assigned when the risk level score is higher than a threshold, or in response to the occurrence of another rule.

In some cases, the method may include assigning a first security policy for the specific file or record for a first user and assigning a second security policy for the specific file or record for a second user. This way, different users will be assigned two different policies for the same file or record. That is, one user will be able to send an email with the specific file, and another user will be disabled from sending the same file. The change in policy may result from a different personal relevance score between the users and the specific process to which the specific file or record is related. For example, the user with the higher personal relevance score may be able to edit a file, while the user with the lower personal relevance score will only be able to view the file's content.

Similarly, the database may include multiple security policies, such that a first security policy is assigned for a first specific file associated with the specific process and a second security policy is assigned for a second specific file associated with the specific process. The different security policies may result from properties of the file or record, such as type, size, date of creation, last date of edition, number of times the file was accessed in a certain period of time, number of times the record was sent outside an organization and the like.

A policy is defined as a combination of a trigger and an action. The trigger may be an action performed by a person, or by a software application, such as sending data, editing, deleting, creating a file/record and the like. The action is a security-related action configured to secure data, such as files and records.

In some cases, the security policy may be applied to the specific file or record only in case the specific file or record was accessed or created by a specific user. That is, the security policy is disabled in other cases and enabled only when a specific user, or a group of users, is involved.

In some cases, the method includes computing a score matching a user to the specific process and assigning the security policy to the specific user according to the score. For example, in case a specific user is more relevant to the specific process, the severity of the security policy can be reduced, and in case a specific user is less relevant to the specific process, the severity of the security policy can be increased.

In some cases, the security policy includes permission definitions for the specific file or record. The permission definitions may include one or more of a list of persons or users capable of reading the specific file or record, editing the specific file or record, deleting the specific file or record, sending the specific file or record, otherwise sharing the specific file or record and perform other actions or processes on the specific file or record. The permission definitions may dictate specific times and locations in which the limitations apply.

In some cases, wherein the security policy includes limiting transmission rules for sending the specific file or record. The limiting transmission rules may dictate who can send the specific file or record, computerized applications allowed to send the specific file or record, and the like. The limiting transmission may include preventing transmission of the specific file or record to a specific location. For example, preventing transmission of a specific document outside a specific country, or to a specific country.

In some cases, the limiting transmission rules prevent the transmission of a specific file or record outside an organization. The organization may be a corporation, non-governmental organization, a governmental organization, and the like.

In some cases, the security policy includes preventing the usage of a specific file or record in a specific software application. for example, the specific file cannot be embedded into a Word document or a PPT file.

In some cases, the security policy includes allowing usage of the specific file or record only in specific one or more applications. That is, for example, sending a specific file via Slack but not via an email message.

In some cases, the security policy includes dictating a memory address allowed to save the specific file or record. The memory address can be assigned to a specific folder or a specific device in an organization.

In some cases, the security policy includes preventing access to a specific file or record. Access can be defined as reading content in a specific file, copying the content, editing the content and the like.

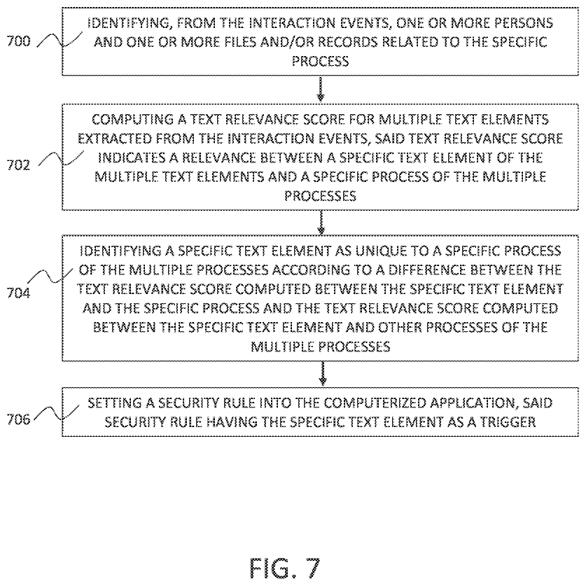

Reference is now made to FIG. 7, which is a flowchart of a method for creating a security rule in a computerized application, in accordance with some embodiments of the invention. The computerized application may have an interface or another mechanism or tool enabling another machine or software to input or inject the rules into the computerized application. such interface may be an API, an SDK, or another type of interface enabling the other machine or software to write or copy data into a memory accessible to the computerized application.

The computerized application may be a computer software operating on a device, for example a messaging application such as Outlook, a business communication application such as Slack, Jira and the like. The computerized application may be an application enabling access to files and/or data records, such as a file system, a data storage service such as AWS, google docs and the like.

At 700, the method includes identifying, from the interaction events, one or more persons and one or more files and/or records related to the specific process. The identification may begin with a process and anchors known to be related to the process. The anchors may be persons or files that are clearly involved in the process. Then, the identifying includes identifying other persons who had relatively high interactions with the anchors, for example over messages or by editing the file known as related to the specific process. The outcome of this process is a list of persons and files/records related to the specific process.

The specific process may be a region of responsibility in an organization, for example accounting, marketing, patent filing, human resources, IT and the like. The specific process may be defined as a set of actions required to be performed by an organization in order to achieve a business goal, such as paying employees' salaries, verifying that all the organization's computers function sufficiently, preparing business contracts with clients and the like. For example, the anchors for the accounting process may be a CFO and other employees having finance in their job description.

In some cases, the specific process may be defined based on at least one of parameters selected from an organizational process, a specific project, a specific vendor, a specific client, a specific team in the organization, a specific division or unit in the organization and the like. For example, all correspondence related to a client #1 may be defined as related to a specific process, while correspondence related to a client #2 may be defined as related to another specific process. Similarly, all correspondence related to a project #1 may be defined as related to a specific process while all correspondence related to a project #32 may be defined as related to another specific process. Further, all correspondence related to a organizational division #1 may be defined as related to a specific process while all correspondence related to an organizational division #3 may be defined as related to another specific process.

At 702, the method includes computing a text relevance score for multiple text elements extracted from the interaction events, the text relevance score indicates a relevance between a specific text element of the multiple text elements and a specific process of the multiple processes. The text elements may be any kind of combination of characters, I.e. a sequence of characters that specifies a search pattern in text, including Regular Expressions (regex). The text element may be a string or may be a combination of multiple strings. The characters in the text elements may be extracted from meetings, email messages, any other type of messages exchanged over a computer software, files, file names, etc. The text elements may be extracted from file names, usernames, the content of messages sent during interaction events, content of the downloaded text, the content of files accessed or sent during interaction events, and the like. The text elements may be assigned an identifier. The text relevance score may be an alphanumeric value indicating the level of relevance of a text element to a process. For example, the output of this process may be a table having 25 different values for many text elements, each value is associated with a specific process. That is, text element #1 may have a first value indicating its relevance to process #1, a second value indicating its relevance to process #2, a third value indicating its relevance to process #3, and so on. The text relevance score may be computed by a function that receives as input the interaction events related to the specific process.

At 704, the method includes identifying a specific text element as unique to a specific process of the multiple processes according to a difference between the text relevance score computed between the specific text element and the specific process and the text relevance score computed between the specific text element and other processes of the multiple processes. For example, in case the difference of the text relevance score for a specific process is higher by 15% than all other text relevance scores of the same text element, the specific text element is defined as unique to the specific process. The value of 15% may be set as a uniqueness threshold that indicates that the text element is unique to the specific process. In some cases, a specific text element may be defined as unique to more than one process. In some cases, the number of processes to which the specific text element can be defined as unique is limited, for example to a quarter of the processes. In some cases, the specific process may be defined as unique to a specific process based on a TF-IDF (Term Frequency Inverse Document Frequency) process in which the number of times a text element appears in a process (in all the events which are related to the process) is compared with the number of processes the term appears in.

In some cases, identifying the specific text element as unique to a specific process includes comparing the text relevance score computed between the specific text element and other processes of the multiple processes to a low threshold and identifying the specific text element only in case all the text relevance scores are lower than the low threshold.

At 706, the method includes setting a security rule into the computerized application, the security rule having the specific text element as a trigger. In some exemplary cases, the computerized application enables users to interact via messages, and the security rule limits the transfer of the messages according to the specific text element. In some exemplary cases, the security rule includes generating a white list of allowed objects based on the text relevance score of multiple text elements representing the objects in the list of allowed objects. In some exemplary cases, the objects in the list of allowed objects are selected from persons, user names, email addresses, messaging usernames, phone numbers, groups of usernames, accounts, files, active directories, data records and domains. In some exemplary cases, the security rule is updated in response to computing a new text relevance score.

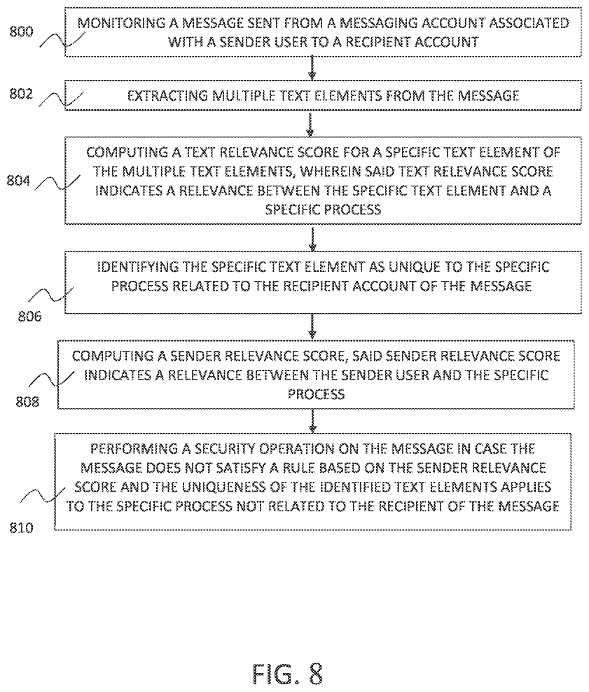

Reference is now made to FIG. 8, which is a flowchart of a computer-implemented method for monitoring anomalous messages related to a specific process, in accordance with some embodiments of the invention.

At 800, the method includes monitoring a message sent from a messaging account associated with a sender user to a recipient account. The messaging account associated with a sender user may be an email account, a phone number, an account in an instant messaging application, an account in a business communication application and the like. The message may be an electronic mail message. The message may be an instant messaging message, such as Facebook Messenger, WhatsApp, Direct message over Twitter and the like. The message may be sent via a business communication application, such as Slack, Jira and the like. The message may be sent via a messaging server communicating with the target user account.

The message may be monitored on the messaging server or when received at a device on which the recipient account is accessed, such as a cellular phone, a laptop, a server, and the like.

At 802, the method includes extracting multiple text elements from the message. The extracting may be done by parsing the message, or parts of the message, such as subject, title, files or records attached to the message, body of the message and the like. The text elements may be any kind of combination of characters, I.e., a sequence of characters that specifies a search pattern in text, including Regular Expressions (regex). The text element may be a string or may be a combination of multiple strings. The text elements may be assigned an identifier.

At 804, the method includes computing a text relevance score for a specific text element of the multiple text elements extracted from the message. The text relevance score indicates a relevance between the specific text element and a specific process. The text relevance score may be an alphanumeric value indicating the level of relevance of a text element to a process. For example, the output of this process may be a table having 25 different values for many text elements, each value is associated with a specific process. That is, text element #1 may have a first value indicating its relevance to process #1, a second value indicating its relevance to process #2, a third value indicating its relevance to process #3, and so on. The text relevance scores may be computed by a function that receives as input multiple text elements that represent the specific process and one or more text elements extracted from the message.

At 806, the method includes identifying that a specific text element is unique to the specific process related to the recipient account of the message. The recipient account may be associated with a person, for example, an employee, or with a process, such as an email account configured to receive all invoices received at the organization. A computerized memory may store a table having on one axis a list of recipient accounts and on the other axis all the relevant processes for the organization. In some cases, the specific process may be defined based on at least one of parameters selected from an organizational process, a specific project, a specific vendor, a specific client, a specific team in the organization, a specific division or unit in the organization and the like.

Identifying that the specific text element is unique to the specific process may be performed according to a difference between the text relevance score computed between the specific text element and the specific process and the text relevance score computed between the specific text element and other processes of the multiple processes. For example, in case the difference of the text relevance score for a specific process is higher by 15% than all other text relevance scores of the same text element, the specific text element is defined as unique to the specific process. The value of 15% may be set as a uniqueness threshold that indicates that the text element is unique to the specific process. In some cases, a specific text element extracted from the monitored message may be defined as unique to more than one process. In some cases, the number of processes to which the specific text element can be defined as unique is limited, for example to a quarter of the processes. In some cases, the specific process may be defined as unique to a specific process based on a TF-IDF (Term Frequency Inverse Document Frequency) process in which the number of times a text element appears in a process (in all the events which are related to the process) is compared with the number of processes the term appears in.

At 808, the method includes computing a sender relevance score, the sender relevance score indicates a relevance between the sender user and the specific process related to the message. For example, based on the text elements extracted from the monitored message, one or more processes may be identified as related to the message. Then, the process checks whether or not the sender is relevant to these processes, to determine whether or not it is justified that this email is sent from a messaging account of this specific person. For example, in case a legal counsel of an organization has a zero relevance score to the process of “product development”, or a relevance score that is lower than a threshold, and the message is identified as relevant only to the process of “product development”, there is no relevance between the sender and the message. In other words, there is no business justification or likelihood that the sender sends the email which is relevant to the specific process. In some cases, the sender relevance score may be computed according to interactions of the sender with files or records relevant to the specific process, for example, editing, viewing, sending, etc. In some cases, the sender relevance score may be computed according to interactions of the sender with persons or users who are uniquely relevant to the specific process.

At 810, the method includes performing a security operation on the message in case the message does not satisfy a rule based on the sender relevance score and the uniqueness of the identified text elements applies to the specific process not related to the recipient of the message. The rule may dictate that the security operation is applied in case the sender relevance score is lower than a relevance threshold. The rule may dictate that the security operation is applied in case the uniqueness of the identified text elements applies to the specific process not related to the recipient of the message. The rule may dictate that the security operation is applied in case both the sender relevance score is lower than a relevance threshold and the uniqueness of the identified text elements applies to the specific process not related to the recipient of the message.

The security operation may include generating a security alert corresponding to the target user and to the monitored message. The security operation may include delaying the message before received at the target user account. The security operation may include blocking the message from receipt at the target user account. The security operation may include sending the message to an analysis messaging account for analysis. The security operation may include raising a security alert from an existing list of alerts, or filtering an alert provided from a third party. In some cases, in case the comparison matches the rule, the method includes computing a risk level score according to the difference between the target interaction weight and the threshold. The difference may include an arithmetical difference, rate between the target interaction weight and the threshold and another function desired by a person skilled the art.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant files and/or records will be developed and the scope of the term file and/or record is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the invention. To the extent that section headings are used, they should not be construed as necessarily limiting. In addition, any priority document(s) of this application is/are hereby incorporated herein by reference in its/their entirety.

What is claimed is:

1. A computer-implemented method for monitoring anomalous messages, the method comprising:
monitoring a message sent from a messaging account associated with a sender user to a recipient account;
extracting multiple text elements from the message;
computing a text relevance score for a specific text element of the multiple text elements, wherein said text relevance score indicates a relevance between the specific text element and a specific process of multiple processes;
identifying the specific text element as unique to the specific process related to the recipient account according to a difference between a first text relevance score computed between the specific text element and the specific process and a second text relevance score computed between the specific text element and other processes of the multiple processes;
computing a sender relevance score, said sender relevance score indicates a relevance between the sender user and the specific process; and
performing a security operation on the message based on the sender relevance score and failure to identify a text element of the message as unique to the specific process related to the recipient.

2. The method of claim 1, wherein the message is an electronic mail message.

3. The method of claim 1, wherein the message is an instant messaging message.

4. The method of claim 1, wherein the message is a Short Message Service (SMS).

5. The method of claim 1, wherein the message is sent via a business communication application.

6. The method of claim 1, wherein the security operation comprises generating a security alert corresponding to the sender user and to the monitored message.

7. The method of claim 1, wherein the security operation comprises delaying the message before received at the recipient account.

8. The method of claim 1, wherein the security operation comprises blocking the message from receipt at the recipient account.

9. The method of claim 1, wherein the security operation comprises sending the message to an analysis messaging account for analysis.

10. The method of claim 1, wherein the security operation comprises filtering an alert.

11. The method of claim 1, wherein the security operation comprises assigning a score to security alerts provided by a third party.

12. The method of claim 1, wherein computing the sender relevance score further comprising collecting a plurality of interaction events between the sender user and users and at least one of files and records identified as related to the specific process.

13. The method of claim 12, wherein collecting the plurality of interaction events is performed using at least one of a group comprising a code sensor, an application programming interfaces (APIs) and a virtual interface, installed on a device operated by the users.

14. The method of claim 12, wherein the interaction events are associated with an interaction contribution date, wherein a weight of at least some of the interaction events decreases over time.

15. The method of claim 12, wherein the plurality of interaction events is selected from a group consisting of: participating in an online meeting, organizing the online meeting, accessing a calendar event, sending email, receiving email, reading a file, sharing a file, creating a file, editing a file, accessing a record, reading a record, sharing a record, creating a record, and editing a record.

16. The method of claim 1, wherein the target interaction weight between the target user and the at least one of messaging account and a user associated with the messaging account is computed as a function of at least one of:
(i) interaction weights between the target user and at least one other user having interaction weights with the user associated with the messaging account, and
(ii) interaction weights between the target user at least one other user having interaction weights with the messaging account.

17. The method of claim 1, wherein monitoring the attempt at a messaging server communicating with the recipient account to which the message was sent.

18. The method of claim 12, wherein the plurality of interaction events are arranged in an interaction graph, wherein the method further comprises updating the interaction graph with new interactions.

19. The method of claim 1, wherein the interaction graph comprises nodes representing one of a specific user, a specific record, a message sent from a sender to a recipient account and a specific file.

20. The method of claim 1, further comprises computing a risk level score according to the difference between the target interaction weight and the threshold.

21. The method of claim 1, further comprises identifying one or more specific processes related to the recipient account.

22. The method of claim 1, further comprises monitoring a message sent from a messaging account associated with a sender user to a recipient account.

23. The method of claim 1, wherein extracting the multiple text elements from the message comprises extracting the multiple text elements from fields selected from the message's subject, attachment's name, a domain associated with the sender, a sender's name, message body, and a combination thereof.
